(19) United States
(12) Patent Application Publication
(10) Pub. No.: US 2006/0170691 A1
(43) Pub. Date: Aug. 3, 2006

(54) Apparatus and method for frame buffer control

(76) Inventor: Ruen-Rone Lee, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/174,637

(22) Filed: Jul. 6, 2005

(30) Foreign Application Priority Data
Jan. 28, 2005 (TW) 094102820

(51) Int. Cl. G09G 5/39

(52) U.S. Cl. 345/531

(57) ABSTRACT

The present invention provides a display control system, which comprises a display for showing a whole frame composed by a plurality of divided frames and a control apparatus controls said plurality of divided frames to said display. In this regards, the control apparatus further comprises a frame buffer composed by a plurality of units, a control module for comprising a draw pointer for pointing to one of said plurality of units to be drawn and a refresh pointer for pointing to one of said plurality of units to be refreshed to said display, a refresh module for refreshing the divided frame stored in said unit, pointed by said refresh pointer, to said display, and a draw module for drawing divided frame into said unit, pointed by said draw pointer.

### BACKGROUND OF THE INVENTION

1. Field of the Invention

The present invention generally relates to display control system, and more particularly to display control system and method for frame buffer control.

2. Description of the Prior Art

In conventional display control systems, all content which is to be displayed on a display or a screen is stored as a bitmap in a memory named frame buffer in the display control system. Generally, there is more than one frame unit, which represents a bitmap corresponding to a whole screen snapshot, in the frame buffer. When the display control system updates one of the frame units to refresh the screen, it orders the screen switched to display the content of another frame unit. For example, when preparing a first frame unit, the screen is displayed the content of a second frame unit. Until the update is finished, the system then orders the screen switched back to the updated frame unit, for example, the first frame unit. Modern three-dimensional graphics display control systems or visual engines provide screen refresh rate at least at 30 frames per second. If the resolution of screen is not too high, the refresh rate may be raised to as fast as 60 frames per seconds.

Please refer to FIG. 1, which is a diagram shows a display control system with a double buffer mechanism. The advantage of the double buffer mechanism is that the content of a frame unit is displayed while preparing the content of another frame unit. Moreover, after a frame unit refreshed as well as another frame unit prepared, the buffer unit switch is taken by the display control system within double buffer mechanism to reduce the screen flicker, shearing, and tearing. However, the most significant drawback of the double buffer mechanism is the buffer frame has to be at least larger than twice size of a bitmap. Furthermore, when a frame unit is finished preparation and another frame unit is not refreshed to the screen yet, the system has to wait for the end of refresh to drawn in this frame unit. Therefore, some display control adapted a triple buffer mechanism, which is incorporated with a third frame unit to be drawn, in order to prevent the wait. However, a frame buffer with a triple size of the screen is needed in the triple buffer mechanism that increases the demands of memory size.

Summarized, there exists a need for a method and apparatus to reduce the demands of frame buffer.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

One object of the present invention is to provide a display control system, which comprises a display for showing a whole frame composed by a plurality of divided frames and a control apparatus controls said plurality of divided frames to said display. In this regards, the control apparatus further comprises a frame buffer composed by a plurality of units, a control module for comprising a draw pointer for pointing to one of said plurality of units to be drawn and a refresh pointer for pointing to one of said plurality of units to be refreshed to said display, a refresh module for refreshing the divided frame stored in said unit, pointed by said refresh pointer, to said display, and a draw module for drawing divided frame into said unit, pointed by said draw pointer.

Another object of the present invention is to provide a display control method for controlling a display control system, which comprises a display for showing a whole frame composed by a plurality of divided frames, and a frame buffer composed by a plurality of units. Each divided frame is stored in each unit. The display control method comprises performing a setup procedure for completely drawing at least one of said plurality of said divided frames, performing a startup procedure for refreshing a unit stored said draw divided frame to said display and drawing another divided frame simultaneously, determining whether said refreshing is completed, wherein continuing said refreshing when said refreshing is not completed, other wisely performing said refreshing to a next unit when said drawing is completed in prior to said refreshing, and determining whether said refreshing to said next unit is completed when said refreshing is completed but said drawing is not, wherein performing said drawing of next divided frame when said drawing is completed, other wisely repeating said refreshing when said drawing is not completed.

A whole frame is divided into two halves in the present invention, drawing a half-frame may takes less time than refreshing a half display, or takes slightly more time than refreshing a half display. However drawing a half-frame should always takes less time than refreshing a whole frame. Under the situation of drawing a half-frame is less than refreshing a half display, the refresh rate in accordance with the present invention could be maintained as the same as the double buffered mechanism. Therefore it requires smaller memory size to achieve the same effort of the double buffered mechanism. Besides, reducing memory size could lead to cheaper cost and lower power consumption. Moreover, next frame could be drawnn during the refresh time of previous frame in accordance with the present invention. It does not need to wait for refreshing before drawing the next frame.

### BREIF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is a diagram shows a display control system with a double buffer mechanism;

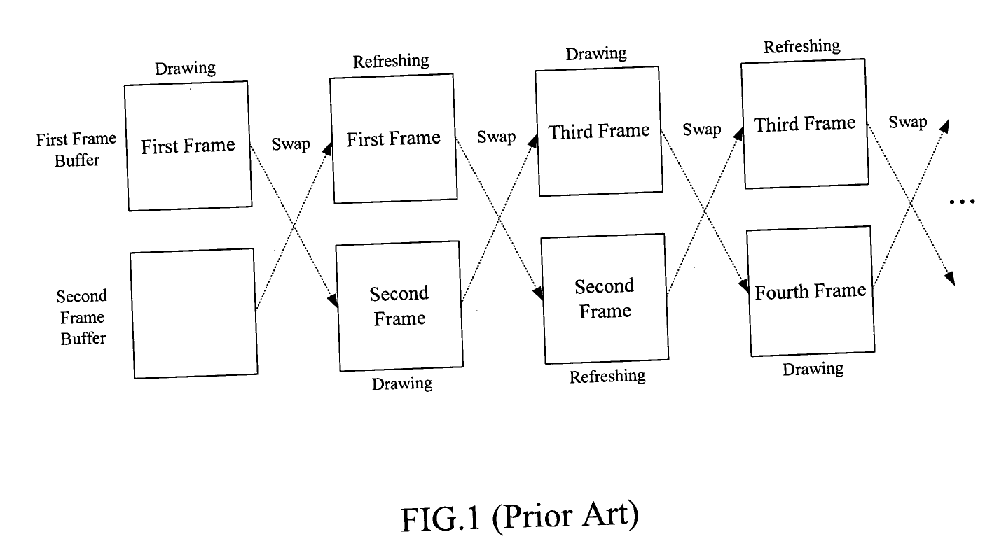

FIG. 2A is a block diagram of a display control system of an embodiment in accordance with the invention;

FIG. 2B is a flowchart diagram of the display control system shown in the FIG. 2A;

FIG. 2C is a timing diagram of an embodiment in accordance with the present invention; and

FIG. 2D is another timing diagram of an embodiment in accordance with the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

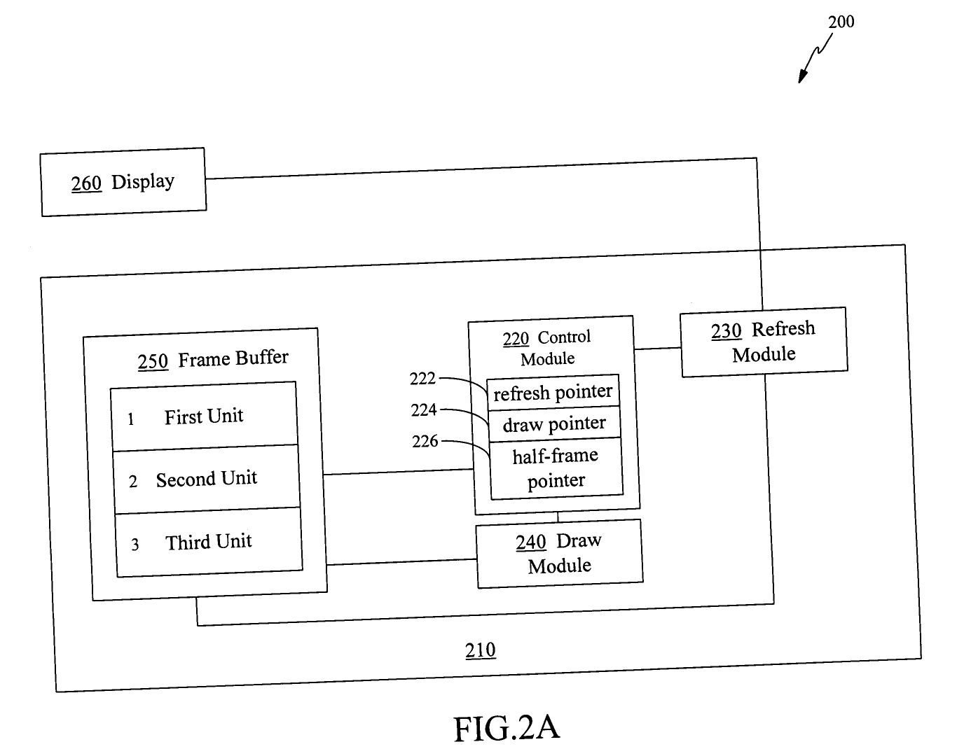

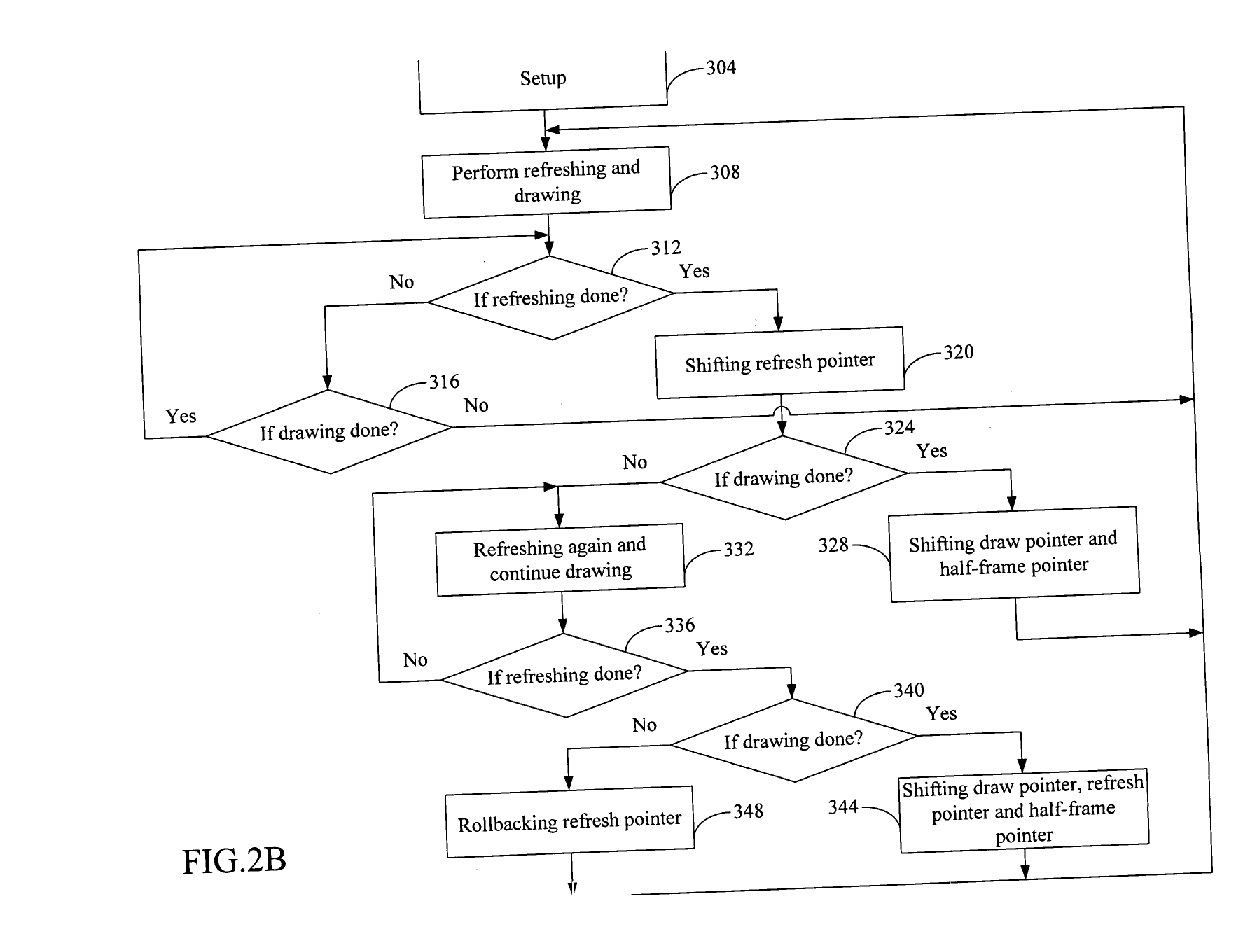

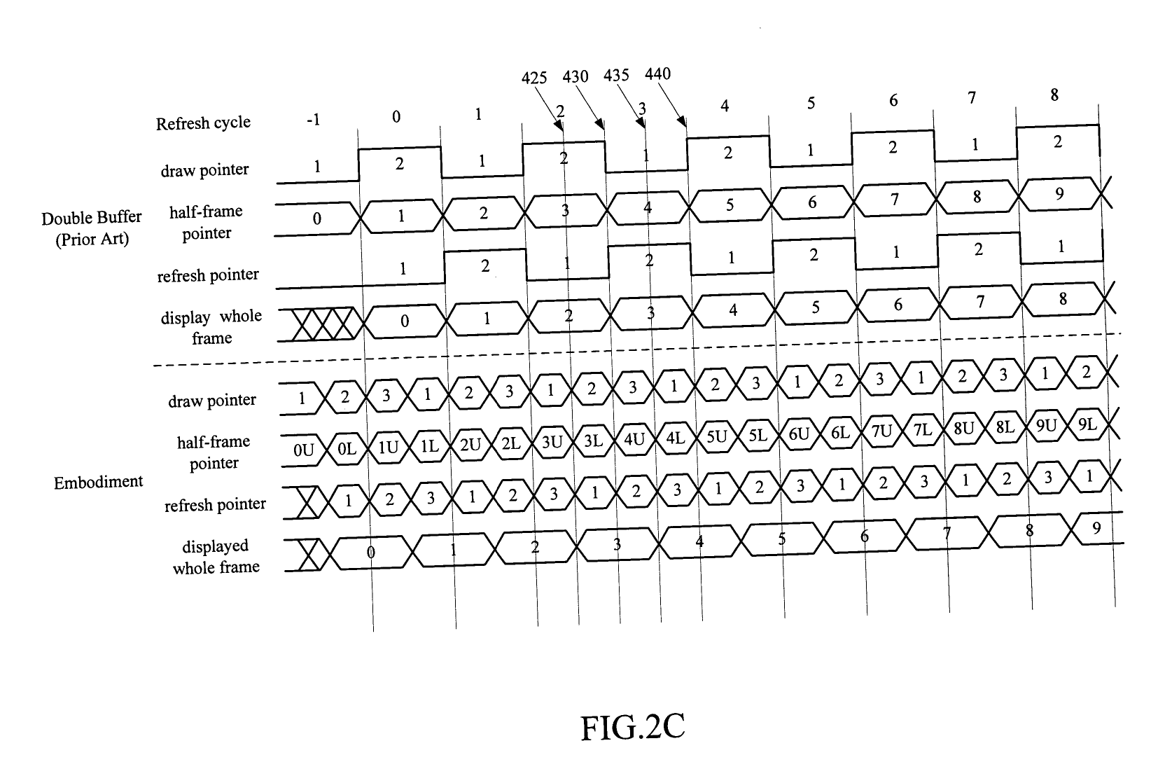

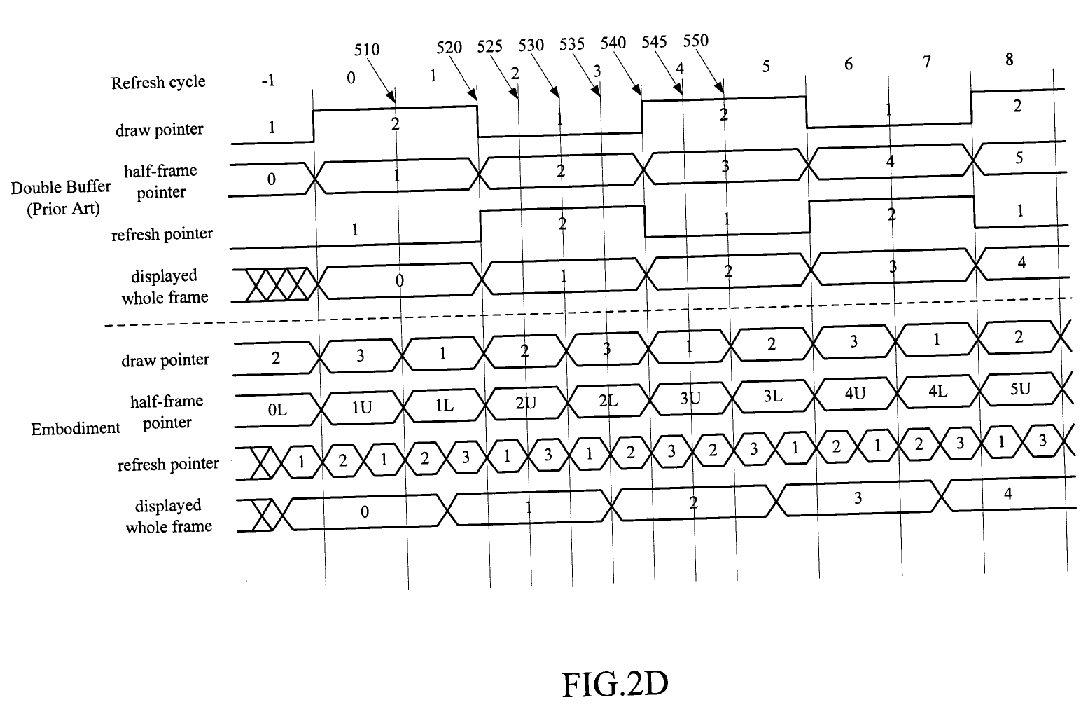

Please refer to FIG. 2A, which is a block diagram of a display control system 200 of an embodiment in accordance with the invention. The display control system 200 comprises a control apparatus 210 and a display 260. Generally, the display control system 200 could comprises other elements, such as central processing unit, system memory and/or other input/output elements, which are not shown in the FIG. 2A. Moreover, the display 260 is configured to display in some resolution and refresh rate, for example the normal resolution of computer is configured as 1024×768, and the common resolution of personal digital assistant is 200×320. The display 260 shows a plurality of continuous frames. However, unlike conventional display which shows a complete screen by the content of a frame, the embodiments in accordance with the invention show a complete screen on the display 260 by the contents of a plurality of frames. Besides, the control apparatus 210 directs the plurality of frames to the display 260.

In this embodiment, the control apparatus 210 comprises a control module 220, a refresh module 230, a draw module 240, and a frame buffer 250. In this regards, the size of the frame buffer 250 could be one and a half screen size of the display 260; that is, the frame buffer 250 could store one and a half screens of the display 260. Furthermore, a complete screen is composed by two half-frames. Therefore the frame buffer 250 comprises three frame units (half-frame), a first unit 1, a second unit 2, and a third unit 3, respectively. The memory size of each frame unit could store half frame of a screen. Since the display 260 shows scanning lines from top to bottom, what the unit stores is an upper frame (upper half-frame) or a lower frame (lower half-frame).

In this regards, the control module 220 could further comprises a refresh pointer 222, a draw pointer 224, and a half-frame pointer 226. The refresh pointer 222 is configured to point to one of the units in the frame buffer 250 to be showed in the display 260, the draw pointer 224 is configured to point to one of the units in the frame buffer 250 to be drawn, and the half-frame pointer 226 is configured to point to one of the two half frames to be drawn, for example, a lower half of a first frame or a upper half of a tenth frame.

In this embodiment, after receiving a display control command from the control module 220, the refresh module 230 shows the content of a unit in the frame buffer 250, pointed by the refresh pointer 222, to refresh the lower or upper half of the display 260. Accordingly, the refresh progress of the display 260 could be controlled by the refresh module 230.

Besides, a draw command could be sent to the draw module 240 from the control module 220 for drawing a unit of the frame buffer 250 pointed by the draw pointer 224. In other words, it is said that the draw module 240 prepares the unit of the frame buffer 250 pointed by the draw pointer 224 according to the content of the half frame pointed by the half-frame pointer 226. In this embodiment, the control module 220 and/or the draw module 240 may execute complicated three dimensional operations for relieving the processing burden of central processing unit. In other cases, other components of the display control system 200 may process the content at first and replicate the content to the frame buffer 250. The present invention does not restrict that the three pointers, the refresh pointer 222, draw pointer 224, and half-frame pointer 226, are maintained in the control module 220. It only requires that the three pointers are maintained in the control apparatus 210.

Please refer to FIG. 2B, which is a flowchart diagram of the display control system 200 shown in the FIG. 2A. First, processing a setup step 304, the control module 220 switches the draw pointer 224 to the first and second unit of the frame buffer 250 for preparing the contents. In this step 304, a first and a second half-frame, belonged to the upper and lower halves of the first frame, would be drawn to the first and second unit, respectively. Moreover, the draw pointer 224 would be changed to point to the third unit, which has no content; the refresh pointer 222 would be pointed to the first unit; and the half-frame pointer 226 would be pointed to a third half-frame. In this embodiment, a N+1th frame is followed by the Nth frame. Each frame could be divided into two half-frames, for example, the upper of the first frame is the mentioned first half-frame, the lower of the first frame is the mentioned second half-frame, and upper of the second frame is the third half-frame etc.

Next, processing a startup step 308, two procedures are performed simultaneously by the control module 220. In a refresh procedure, after receiving a refresh command, issued by the control module 220, the refresh module 230 refreshes the upper or lower half of the display 260 by updating one prepared unit of the frame buffer 250 pointed by the refresh pointer 222. In another simultaneous draw procedure, after receiving a draw command, issued by the control module 220, the draw module 240 prepares a unit of the frame buffer 250 pointed by the draw pointer 240. In the following step 312, the control module 220 determines that whether the refresh procedure finished or not. If the upper or lower half of the display 260 is already refreshed by the content pointed by the refresh pointer 222, a step 320 would be processed; otherwise, another step 316 would be processed.

In the step 316, the control module 220 determines that whether the draw procedure is done. If these two procedures are not finished yet, the flowchart returned to the step 308 for continuing these two procedures; otherwise, it goes to the step 312 and keeps waiting for the refresh procedure to precede the step 320.

In the step 320, the control module 220 shifts the refresh pointer 222 to pointing to the next unit in prior to processing a step 324. As mentioned before, these three units are in a circular order, such that the first, second, third, first, and goes on. In the following step 324, the control module 220 determines that whether the draw procedure is done. If done, it goes to a step 328; otherwise, a step 332 would be processed. When both the procedures are finished, for example, the draw procedure is done before the refresh procedure, the control module 220 shifts the draw pointer 224 to pointing to the next unit and shifts the half-frame pointer 226 to pointing to the next half-frame in the step 328. Then it returned back to the startup step 308 for next display circle.

When the refresh procedure is done in prior to the draw procedure, the control module 220 further commands the refresh module refresh the display 260 by updating the content of the unit pointed by the refresh pointer 222 in the step 332. In other words, the refresh procedure is executed again. Simultaneously, the draw procedure is still performed by the draw module 240 to one unit of the frame buffer 250 at the same time. In a step 336, the control module 220 determines that whether the refresh procedure performed in the step 332 is done or not. If done, it would be advanced to a step 340; otherwise, the refresh procedure of the step 332 and the draw procedure would be continued.

Furthermore, in the step 340, the control module 220 again determines that whether the draw procedure performed is done or not. If the unit pointed by the draw pointer 224 is drawn completely, the flowchart goes to a step 344; otherwise, another step 348 would be processed. The control module 220 shifts the refresh pointer 222 to pointing to the next unit, shifts the draw pointer 224 to pointing to the next unit, and shifts the half-frame pointer 226 to pointing to the next half-frame in the step 344. Next, it returned to the startup step 308 for next half-frame cycle. However, in the step 348, the control module 220 shifts the refresh pointer 222 to pointing to previous unit since there is not prepared unit. Finally, it also returned to the startup step 308 for repeating the refresh cycle of the previous unit.

In this embodiment, the executing speeds of the refresh and draw procedures would affect the flowchart shown in the FIG. 2B. Generally, refreshing a whole frame requires more time than drawing the content of a whole frame. Therefore real-time display is possible in such assumption. However, a frame is divided into two half-frames in the present invention. Hence, drawing a half frame is possible less than refreshing a half frame. If drawing a half frame is slightly longer than refreshing a half frame, it also could be controlled to display in real-time.

Please refer to FIG. 2C, which is a timing diagram of an embodiment in accordance with the present invention. The timing diagram of the FIG. 2C is situated at that drawing a half frame requires less time than refreshing a half frame. When at a moment 430, the refresh pointer 222 is pointing to the prepared second unit 2, which contains the content drew at a previous moment 425. Besides, the content is corresponding to the lower half of a third whole frame. Moreover, the half-frame pointer 226 is pointing to the upper half of a fourth whole frame and the draw pointer 224 is pointing to the third unit 3 at this moment 430.

Here, the steps 308, 312, 320, 324, and 328 shown in the FIG. 2B are processed and mapped to the FIG. 2C, accordingly. The step 308 shown in the FIG. 2B is processed at the moment 430; i.e., a refresh procedure and a draw procedure are performed simultaneously. In this refresh procedure, the content of the second unit 2, pointed by the refresh pointer 222, would be updated to the display 260 by the refresh module 230. In other words, the content of the second unit 2, the lower part of the third whole frame, would be refreshed to the lower part of the display 260. Meanwhile, the third unit 3, pointed by the draw pointer 224, would be drawn by the draw module 240 in the draw procedure. It is said that the upper part of the fourth whole frame would be drawn to the third unit 3. Next, the flowchart goes to the step 312. Since the FIG. 2C shows the situation that drawing a half frame requires less time than refreshing a half frame, the draw procedure would be done in prior to the refresh procedure. In one example of this embodiment, in case the draw procedure is completed but the refresh procedure is not, the control module 220 would determine that the refresh procedure is not finished in the step 312. Then the flowchart goes on executing step 316. However, the flowchart would return to the step 312 due to the completed draw procedure. In another example of this embodiment, in case both procedures are done during processing the step 312, it goes to the step 320. The refresh pointer 222 is shifted to pointing to the next unit, the third unit 3, from the previous unit, the second unit 2 in this step 320. In the next step 324, it goes to the step 328 since the refresh procedure is done. The refresh pointer 222 is shifted to the next unit, the first unit 1, and the half-frame pointer 226 is shifted to the lower part of the fourth whole frame from the upper part in the step 328. When all mentioned steps are finished, it is at another moment 435 and the flowchart goes back to the startup step 308.

As shown in the FIG. 2C, in respect of refresh rate of the whole frames, applying double buffer is as the same as applying system and method provided by the present invention. However, the present invention utilizes smaller frame buffer to keep the same refresh rate. The memory could be downsized to fit in smaller and smaller consumer electronics.

Please refer to FIG. 2D, which is another timing diagram of an embodiment in accordance with the present invention. The timing diagram of the FIG. 2D is situated at that drawing a half frame requires longer time than refreshing a half frame but less time than refreshing a whole frame. When at a moment 530, the refresh pointer 222 is pointing to the prepared first unit 1, which contains the content drew at a previous moment 510. Besides, the content is corresponding to the lower half of a first whole frame. Moreover, the half-frame pointer 226 is pointing to the lower half of a second whole frame and the draw pointer 224 is pointing to the third unit 3 at this moment 530.

Here, the steps 308, 312, 320, 324, 332, 336, 340, and 340 shown in the FIG. 2B are processed and mapped to the FIG. 2D, accordingly. The step 308 shown in the FIG. 2B is processed at the moment 530; i.e., a refresh procedure and a draw procedure are performed simultaneously. In this refresh procedure, the content of the first unit 1, pointed by the refresh pointer 222, would be updated to the display 260 by the refresh module 230. In other words, the content of the first unit 1, the lower part of the first whole frame, would be refreshed to the lower part of the display 260. Meanwhile, the third unit 3, pointed by the draw pointer 224, would be drawn by the draw module 240 in the draw procedure. It is said that the lower part of the second whole frame would be drawn to the third unit 3.

During the third refresh cycle from the moment 530 to another moment 535 shown in the FIG. 2D, the refresh procedure is determined that it is not completed in the step 312. Hence the flowchart goes on the step 316. Since the situation shown in the FIG. 2D is that drawing a half frame requires longer time than refreshing a half frame but less time than refreshing a whole frame, the draw procedure is determined that it is not completed in the step 316. Therefore the flowchart returns to the startup step 308.

During the moment 535 and another later moment 540, it goes to execute the step 320 from the step 312 since the refresh procedure of the first unit 1 is completed. The refresh pointer 222 is shifted from the first unit 1 to the next unit, the second unit 2, which has contents about the upper part of a second whole frame drew at a previous moment 520. In this embodiment, if the draw procedure of the third unit 3 is determined as completeness in the step 324, the step 328 is followed; otherwise, the step 332 is executed consequently. Since the draw time is longer than the refresh time in this example, the draw procedure of the third unit 3 is not completed in the step 324. Hence the step 328 is followed. In other words, the content of the second unit 2, pointed by the refresh pointer 222, which contains the upper part of the second whole frame, would be updated to the upper part of the display 260. The draw procedure of the third unit 3, which should contains the lower part of the second whole frame pointed by the half-frame pointer 226, is still proceed at the moment 540. Next, the draw procedure would be determined again in the following step 336. In accordance with the situation of this example shown in the FIG. 2D, the draw procedure is determined completed in the step 336. The flowchart carries on the step 344 between a moment 540 and a later moment 545. The refresh pointer 222 is shifted to pointing to the third unit 3 from the original second unit 2, the draw pointer 224 is shifted to pointing to the first unit 1 from the third unit 3, and the half-frame pointer 226 is shifted to pointing to the upper half of a third whole frame from the lower part of the second whole frame.

The present invention does not restrict that a whole frame is divided into two halves merely. A whole frame could be constructed by multiple divided frames. The number of frame buffer units is not restricted as three. When the draw speed is faster than the refresh speed, the number of units could be equaled to or less than the number of divided frames, which constructed a whole frame. Reversely, when the draw speed is slower than the refresh speed, the memory size would be less than those required in the double buffered example. Therefore, the apparatus and method provided by the present invention could apply to embedded systems or system-on-chip for reducing memory sized, cost, and power consumption.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A display control system, comprising:
a display shows a whole frame composed by a plurality of divided frames; and
a control apparatus controls said plurality of divided frames to said display, comprising:
a frame buffer, wherein said frame buffer comprising a plurality of units, each of divided frame is stored in each unit;
a control module, comprising a draw pointer for pointing to one of said plurality of units to be drawn and a refresh pointer for pointing to one of said plurality of units to be refreshed to said display;
a refresh module for refreshing the divided frame stored in said unit, pointed by said refresh pointer, to said display; and
a draw module for drawing divided frame into said unit, pointed by said draw pointer.

2. A display control system of claim 1, wherein the number of said plurality of units is less than the number of said plurality of divided frames.

3. A display control system of claim 2, wherein said drawing, by said draw module, is done in prior to said refreshing, by said refresh module.

4. A display control system of claim 2, wherein the number of said plurality of units is three, said whole frame is composed by two half-frames.

5. A display control system of claim 4, wherein said drawing, by said draw module, is done in prior to said refreshing, by said refresh module.

6. A display control system of claim 6, wherein said control module further comprising a half-frame pointer for pointing to a half-frame to be drawn, wherein said half-frame, pointed by said half-frame pointer, is drawn into said unit, pointed by said draw pointer, by said draw module.

7. A display control system of claim 4, wherein said drawing, by said draw module, is slower than said refreshing of one half-frame and quicker than said refreshing of two half-frames.

8. A display control system of claim 1, wherein said control module, issues a refresh command to said refresh module for said refreshing, and a draw command to said draw module for said drawing.

9. A control apparatus for controlling a display control system, wherein said display control system comprising a display for showing a whole frame composed by a plurality of divided frames, said control apparatus comprising:
a frame buffer, wherein said frame buffer comprising a plurality of units, each of divided frame is stored in each unit;
a control module, comprising a draw pointer for pointing to one of said plurality of units to be drawn and a refresh pointer for pointing to one of said plurality of units to be refreshed to said display;
a refresh module for refreshing the divided frame stored in said unit, pointed by said refresh pointer, to said display; and
a draw module for drawing divided frame into said unit, pointed by said draw pointer.

10. A control apparatus of claim 9, wherein the number of said plurality of units is less than the number of said plurality of divided frames.

11. A control apparatus of claim 10, wherein said drawing, by said draw module, is done in prior to said refreshing, by said refresh module.

12. A control apparatus of claim 10, wherein the number of said plurality of units is three, said whole frame is composed by two half-frames.

13. A control apparatus of claim 12, wherein said drawing, by said draw module, is done in prior to said refreshing, by said refresh module.

14. A control apparatus of claim 12, wherein said control module further comprising a half-frame pointer for pointing to a half-frame to be drawn, wherein said half-frame, pointed by said half-frame pointer, is drawn into said unit, pointed by said draw pointer, by said draw module.

15. A control apparatus of claim 12, wherein said drawing, by said draw module, is slower than said refreshing of one half-frame and quicker than said refreshing of two half-frames.

16. A control apparatus of claim 9, wherein said control module, issues a refresh command to said refresh module for said refreshing, and a draw command to said draw module for said drawing.

17. A display control method for controlling a display control system, wherein said display control system comprising a display for showing a whole frame composed by a plurality of divided frames, and a frame buffer composed by a plurality of units, wherein each of divided frame is stored in each unit, said display control method comprising:
performing a setup procedure for completely drawing at least one of said plurality of said divided frames;
performing a startup procedure for refreshing a unit stored said draw divided frame to said display and drawing another divided frame simultaneously;
determining whether said refreshing is completed, wherein continuing said refreshing when said refreshing is not completed, other wisely performing said refreshing to a next unit when said drawing is completed in prior to said refreshing; and
determining whether said refreshing to said next unit is completed when said refreshing is completed but said drawing is not, wherein performing said drawing of next divided frame when said drawing is completed, other wisely repeating said refreshing when said drawing is not completed.

18. A display control method of claim 17, wherein the number of said plurality of units is less than the number of said plurality of divided frames.

19. A display control method of claim 18, wherein the number of said plurality of units is three, said whole frame is composed by two half-frames.

20. A display control method of claim 19, wherein said setup procedure is completely drawing two of said plurality of said divided frames.

21. A display control method of claim 19, wherein the circular order of said three units is listed as followed: a first unit, a second unit, a third unit, and said first unit etc.
